(19) United States
(12) Patent Application Publication
(10) Pub. No.: US 2010/0186420 A1
(43) Pub. Date: Jul. 29, 2010

(54) FROZEN AERATED FOOD PRODUCT COMPRISING SURFACE-ACTIVE FIBRES

(76) Inventors: Mark John Berry, Sharnbrock (GB); Andrew Richard Cox, Sharnbrook (GB); Weichang Liu, Shanghai (CN); Simeon Dobrev Stoyanov, Vlaardingen (NL); Weizheng Zhou, Shanghai (CN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/445,592

(22) PCT Filed: Oct. 1, 2007
(86) PCT No.: PCT/EP07/60374

§ 371 Date: Apr. 15, 2009

(30) Foreign Application Priority Data
Oct. 17, 2006 (EP) 06122405.1
Jun. 19, 2007 (EP) 07110525.8

(51) Int. Cl. A23G 9/04; A23P 1/16

(52) U.S. Cl. 62/1; 426/565

(57) ABSTRACT

The invention relates to a frozen aerated frozen food product having an overrun of at least 30% comprising 0.001 to 10 weight-% (wt-%), based on the total weight of the frozen aerated food product, of surface-active fibres.

The invention relates to a frozen aerated food product having an overrun of at least 30% comprising 0.001 up to 10 weight-% (wt-%), based on the total weight of the frozen aerated food product, of surface-active fibres.

A surface-active agent or surfactant is a substance that lowers the surface tension of the medium in which it is dissolved, and/or the interfacial tension with other phases. Accordingly, it is positively adsorbed at the liquid/gas and/or at other interfaces.

Surface-active agents are widely used industry, for instance in foods, cleaning compositions and personal care products. In foods, they are used to achieve emulsions of oily and water-phases, such as in fat spreads or mayonnaise

In foods, surface-active materials are commonly used to prepare emulsions and to facilitate aeration. Edible emulsions are used as a base for many types of food products. Mayonnaise compositions, for example, comprise edible oil-in-water emulsions that typically contain between 80 to 85% by weight oil, and egg yolk, salt, vinegar and water. Mayonnaise compositions are enjoyed by many consumers, and particularly, on sandwiches, in dips, with fish and other food applications. The oil present in the edible emulsions used in such food products is generally present as droplets dispersed in the water phase. In addition to droplet size and the amount of droplets dispersed, the close packing of the oil droplets results in the characteristic rheological behaviour of the emulsions used to make the desired food product, such as mayonnaise or margarine.

In ice cream, surface active agents are added to both emulsify the oil phase and also to aerate the product during the shear freezing process. Typically, milk proteins are used as the principal aerating agent. Although ice cream formulations can be readily aerated using conventional equipment, the stability of the air phase is partly dependent on storage temperature. If the ice cream is subject to poor storage or a poor distribution chain where the temperature may warm or fluctuate, this leads to coarsening of the air phase. To the consumer, this can be perceived as a colder eating, more icy, faster melting product which is less desirable.

The surface-active agents that are most commonly used in food applications comprise low molecular weight emulsifiers that are primarily based on fatty acid derivatives.

Examples include: lecithins, monoglycerides (saturated and unsaturated), polysorbate esters (Tweens), sorbitan esters (Spans), polyglycerol esters, propylene glycol monostearate, sodium and calcium stearoyl lactylates, sucrose esters, organic acid (lactic, acetic, tartaric, succinic) esters of monoglycerides. Proteins and other surface-active biopolymers can also be used for this purpose. Typical examples of food proteins include milk proteins (caseins and whey proteins), soy protein, egg protein, lupin protein, pea protein, wheat protein. Examples of other surface-active biopolymers include gum Arabic, modified surface active pectin and OSA modified starch.

Typical surface active agents like proteins and emulsifiers or fats that are used for stabilisation of aerated food products are very good at providing short term foam stability (period of hours to days) but are not very good at providing long term foam stability, which is mainly limited by the disproportionate process, where gas diffuses form small to big bubbles, which leads to foam coarsening eventually complete loss of air. This problem can be partly avoided by gelling the continuous phase, but in many cases this leads to undesired textural changes. It has been proposed that by creating interfaces with very high dilatational elasticity the disproportionation process could be completely stopped and one of the proposed way to do so was to use surface active colloidal particles

### Colloid Particles as Surface Active Agents

Recently, the interest in the study of solid particles as emulsifiers of dispersed systems has been re-awakened. Much of this activity has been stimulated by the research of Binks and co-workers (Binks, B. P. Curr. Opin. Colloid Interface Sci. 2002, 7, 21), though the principles of such stabilisation were observed at least 100 years ago (Ramsden, W. Proc. R. Soc. London 1903, 72, 156).

Whilst the use of particles to stabilise o/w, w/o and duplex emulsions has been described, much less research has been carried out on particle stabilised foams.

### Particle Self Assembly

In between the realm of stable and unstable dispersions is the area of self assembly, which is defined as ability of particles to self associate into new structures without guidance or management from an outside source, which is mainly due to the interparticle forces and requires fine balance between attractive and repulsive forces. Obviously if these forces always repulsive then dispersions will be very stable and the particles will not self assemble. If these forces are always attractive then they will flocculate and the dispersion will become unstable. The same principle applies for the total strength of the forces—if the interactions are too weak (much less then kT, the thermal energy) then thermal fluctuations will disrupt the self assembled structures. Conversely, if the interaction are two strong (much bigger then kT) then self-assembled structures are formed leading to destabilization of the dispersion, flocculation, and precipitation. Particle self assembly can be reversible or irreversible, equilibrium or non equilibrium i.e. self assembled structures are kinetically trapped into meta stable state.

In the process of self-assembly, the components must be able to move with respect to each other. Their steady-state positions balance mutual attractive and repulsive interaction forces. Some of the most well-know forces are:
Electrostatic interaction: Colloidal particles often carry an electrical charge and therefore attract or repel each other. The charge of both the continuous and the dispersed phase, as well as the mobility of the phases are factors affecting this interaction.
van der Waals forces: This is due to interaction between two dipoles which are either permanent or induced. Even if the particles don't have a permanent dipole, fluctuations of the electron density gives rise to a temporary dipole in a particle. This temporary dipole induces a dipole in particles nearby. The temporary dipole and the induced dipoles are then attracted to each other. This is known as van der Waals force and is always present, is short range and usually is attractive.

The combination of electrostatic and van der Waals forces are usually referred as DLVO forces, while the rest of the forces are referred as non-DLVO forces. Some of the best known non-DLVO forces are:
Excluded Volume Repulsion: forces which prevent any overlap between hard particles.
Steric forces between polymer-covered surfaces or in solutions containing non-adsorbing polymer can modulate interparticle forces, producing an additional repulsive steric stabilization force or an attractive depletion force between them.
Short range forces due to Hydrogen Bonding. Molecules comprising electronegative atoms (O, N, F, Cl) with a H-atom attached can form exceptionally strong, through short range (0.1-0.17 nm) and directional bonds, according to X-H . . . Y, where X denotes the mother molecule and Y denotes the linked molecule. This type of bond explains structural properties of water/ice, protein folding and DNA-double helix formation. Due to their very short range interactions due to hydrogen bonds sometimes are referred as sticky interactions.
Forces due to the Hydrophobic Interactions: If one attempts to disperse hydrophobic particles or molecules in water, it is more energy efficient for the particles to stick together and to minimize the area having contact with water. This attraction is caused by strong hydrogen mediated water-water-interactions, repelling molecules that disturb the water structure formation. The range of this interaction is in the range of few nanometers.

Depending on the interplay between these forces, colloidal a dispersion may be stable, meta stable or unstable. In order to trap a dispersion of particles in a meta-stable state, allowing self-assemble, one can use a number of methods:
Removal of the electrostatic barrier that prevents aggregation of the particles. This can be accomplished by the addition of salt to a suspension or changing the pH of a suspension to effectively neutralize or “screen” the surface charge of the particles in suspension. This diminishes the repulsive forces that keep colloidal particles separate and allows for coagulation due to van der Waals forces.
Addition of a charged polymer flocculant. Polymer flocculants can bridge individual colloidal particles by attractive electrostatic interactions. For example, negatively charged colloidal silica particles can be flocculated by the addition of a positively charged polymer.
Addition of nonadsorbed polymers called depletants that cause aggregation due to entropic effects.

In the self-assembly of larger components (meso- or macroscopic objects) the interaction can often be selected and tailored and can include (besides the interactions mentioned above) gravitational attraction, external electromagnetic fields, capillary and entropic interactions, which are not important in the case of single molecules (Whitesides and Grzybowski, Science, 295, 2002).

### Surface Active Particles

Surface active particles are particles which can spontaneously accumulate at an interface or surface between the continuous media and second phase—for example between water and oil or air-water). The Surface chemistry of surface active particles could be heterogeneous having hydrophobic and hydrophilic patches (some time called Janus particles), which resemble surfactant properties and accumulate to the interface, with a contact line following the boundary between the patches. In the case when particles have homogeneous surface chemistry then they accumulate at the interface due to their wetting properties determined by the three phase contact angel θ between the particle/phase 1 (continuous phase where particles are dispersed) and the second phase 2 creating the interface with phase 1. In this case the surface activity, expressed as a desorption energy (E_{des}) is a function of the particle size, R, the surface tension, γ, between phase 1 and 2 and particle contact angle, θ, which for the case of a spherical particle is:

ΔE_{des}=πR²γ(1±cos θ)²

From this formula, it follows that the maximum desorption energy is obtained at a contact angle of 90°. Simple estimation shows that even for very small nanometer size particles and for typical values of surface/interfacial tension the maximum of this energy could exceed values of 1000 kT, where k is the Boltzmann constant and T is ambient thermodynamic temperature of the system measured in Kelvin. This compares with values of typical molecular surfactants of just a few kT.

As a result, the advantage of particle stabilisation is that it is almost impossible to displace an adsorbed particle once adsorbed to an interface. This gives particle stabilised emulsions and foams excellent stability, especially with respect to ripening mechanisms such as dis-proportionation.

Whilst the use of particles to stabilise o/w, w/o and duplex emulsions is known, much less research has been carried out on particle stabilised foams. This is partially due to the fact that though particles could have potentially excellent foam stabilisation capacity dispersion from spherical particles usually have very low foam ability if aerated using conventional aeration methods as shaking and whipping.

### Shape Anisotropic Particles (Fibers) as Surface Active Agents

Furthermore, majority of the current work has been mainly focusing on very low aspect ratio (spherical) particles. Only recently it has been demonstrated by Alargova et al. (Langmuir, 2006, 22, 765-774) that high aspect ratio particles, such as epoxy resin polymeric rods can be used to provide interfacial stabilisation to emulsions and foams. There they show that provided that particles have the right contact angle and high aspect ratio they could have an excellent foaming and foam stabilisation capacity. The method for production of these polymeric rods has been outlined in WO-A-06/007393 (North Carolina State University), which discloses a process for preparing micro-rods using liquid-liquid solvent attrition in presence of external shear. The method dissolving a polymer into a solvent 1. Solvent 1 is also miscible with highly viscous solvent 2, while the polymer is not soluble into the resulting mixture of solvent 1 and 2. Then droplets comprising of polymer solution in solvent 1 are introduced subsequently into solvent 2 while applying shear stress such that the polymer solution droplets form micro-rods, which solidify due to attrition of solvent 1. This process obviously gives polymeric rod like particles, which have homogeneous surface properties determined entirely by the properties of the polymer i.e. contact angle between air water interface and solid polymer. Therefore it is important to use polymers solution, having right wetting properties.

The disadvantage of the methods outlined above is that once made, the particles have fixed properties, which might be not always suitable for the specific formulation and applications.

Surprisingly we have found that we can solve this problem by using surface active fibres in frozen aerated products. Such surface active fibres can have the surface activity by their nature or they can be modified to obtain the surface activity. The modification (chemically and/or physically) can be carried out before the fibres are used in the production of the frozen aerated food product and/or it can be carried out during the production of the frozen aerated food product.

In the context of the present invention a surface active fibre can be a fibre, which has the required surface activity (as defined below) by its nature or it can be a modified fibre which is modified by a surface active particle. It is also possible to modify (by a surface active particle) a fibre which is surface active. The processes of modification are described below.

When the modification takes place during the production of the frozen aerated food product, it is usually achieved by a self assembly process.

A self assembly process (as outlined above) takes place between two types of components (i) surface active particles, which may or may not have preferable fiber like geometry (let say with a spherical or plate like shape) and (ii) fibers, which might not have surface activity (let say hydrophilic), which then can self assemble when mixed together due to attractive or sticky interaction between them which are naturally occurring between the particles due to their intrinsic material properties. For example, both types of particles are made from cellulose material, which can form an attractive hydrogen H-bond. Alternatively, one or both particles may be modified so that they can attract each other and self assemble (let say both particle are made slightly hydrophobic, which will self assemble due to hydrophobic interaction or one of the particle has slight negative, while another slight positive charge).

It might be that only one or both type of particles do give have good foam ability and stability but the combined system comprising of self assembled particle aggregates has superior foam ability and stability than each of the particles alone.

The modification of the fibres (to obtain surface active fibres) can be carried out by adding the fibres and the surface active particles in two steps or both components can be added in one step and the process can be started by activation (i.e. aeration, stirring etc).

The advantage of the above outline finding is that we can dose both type of particles independently which will change the properties of self assembled surface active material at will at the point of use. It is important to realise that depending on the properties of fiber type particles the self assembly can occur on two different levels: In the case of non surface active fibers we can have a lower level of self assembly between surface active (hydrophobic) particles and hydrophilic fibers leading to aggregates with amphiphilic properties in the bulk and second higher level of self assembly at air/gas which occurs at the point of gas entrapment (aeration), where surface active particles or complex between them and fibers will adsorb first, while enriching the interface, which in turn due the attractive interaction with the remaining fibers will lead to the consecutive interfacial attachment and self assembly. Depending on the size a single fiber can bridge several particles. Therefore, when considered collectively the fibers can act as a scaffolding for the whole surface or interface. In the case when both fibers and particles are surface active, but still can self assemble one can expect both of them to adsorb at the interface and self assemble predominantly there, forming a network of adsorbed fibers and surface active particles, which can act as a glue between the rods. Obviously in this case the structure will be highly dependent on the relative size and concentration of each of the two components.

Surprisingly, it has now been found that that a frozen aerated food product having an overrun of at least 30%, comprising 0.001 to 10 wt-%, based on the total weight of the frozen aerated food product, of surface-active fibres which have an aspect ratio of 10 to 1,000, has excellent overall properties.

The extent of aeration is measured in terms of “overrun”, which is defined as:

$$overrun / \% = \frac{weight of mix - weight of aerated product}{weight of aerated product} \times 100$$

where the weights refer to a fixed volume of product/mix. Overrun is measured at atmospheric pressure.

A frozen aerated food product according to the present invention shows very good air phase stability, both in terms of retaining air volume and retaining stable bubbles. It is also possible to use liquids oils, such as sunflower oil, and easily obtain a frozen aerated food product which has good stability. With the commonly used emulsifiers it is not easy obtainable. Liquid oils in the context of the present invention means that at least 50% of the oil by weight is liquid at the consumption temperature.

A frozen aerated food product also exhibits good stability of the air phase, particularly when subject to temperature abuse. A frozen aerated product according to present invention is very stable in regard to storage and temperature change and also demonstrates good melting properties. It is also possible to freeze the food product according to present application some time after the aeration process. That means that the product can be transported without being frozen (without loosing its shape).

Therefore, the present invention relates to a frozen aerated food product having an overrun of at least 30%, comprising 0.001 to 10 wt-%, based on the total weight of the frozen aerated food product, of surface-active fibres which have an aspect ratio of 10 to 1,000, has excellent overall properties.

Preferably a frozen aerated food product according to the present invention comprises 0.01 to 10 wt-%, based on the total weight of the frozen aerated food product, of at surface active fibres.

A preferred frozen aerated food product comprises 0.01 to 8 wt-%, more preferred 0.01 to 5 wt-%, based on the total weight of the frozen aerated food product, of at least one surface active material.

By the word “fibre”, we mean any insoluble, particulate structure, wherein the ratio between the length and the diameter ranges from 10 to infinite. “Insoluble” means insoluble in water. The diameter means the largest distance of the cross-section. Length and diameter are intended to mean the average length and diameter, as can be determined by (electron) microscopic analysis, atomic force microscopy or light-scattering. The fibre topology might be liner or branched (star-like). The aspect ratio in this case is defined as aspect ratio of the longest branch.

“Surface-active fibres” in the context of the present invention can be unmodified fibres or fibres modified by surface active particles (which is an assembly product of surface active particles and fibres).

The fibres used in the present invention have a length of about 0.1 to about 100 micrometer, preferably from about 1 to about 50 micrometer. Their diameter is in the range of about 0.01 to about 10 micrometer. The aspect ratio (length/diameter) is generally more than 10, preferably more than 20 up to 100 or even 1,000.

Surface active fibres are used for the embodiment of the present invention. If the fibres do not intrinsically have such properties they are modified in such a way that they show such properties. The modification is carried out by physical and/or chemical reaction of fibres with a surface active particle.

This modification of the fibres can happen before the fibres are used to produce a frozen aerated product or the modification can be carried out during the production of the frozen aerated product. Methods to do these modifications are described below.

Usually surface active fibres, unmodified or modified, will exhibit a contact angle at an air/water or at an oil/water interface between 60° and 120°, preferably between 70° and 110°, more preferably between 80° and 100°.

The contact angle of the fibres can be measured using the gel-trapping technique as described by Paunov (Langmuir, 2003, 19, 7970-7976) or alternatively by using commercial contact angle measurement apparatus such as the Dataphysics OCA20.

The contact angle of the fibres can be measured before the addition to the frozen aerated product. If the fibres are part of a frozen aerated product, the fibres have to be isolated and purified according to known process before the contact angle can be measured. The presence of surface-active fibres at an interface or surface can be determined using microscopy techniques such as Scanning Electron Microscopy (SEM).

The surface-active fibres as described in this invention may be sub-divided into two classes, based upon the materials used to make them:
surface-active waxy fibres
(ii) surface-active non-waxy fibres

Preferably, the surface-active waxy as well as the surface-active non-waxy fibres are food grade. In the context of the present invention food grade fibres are not toxic, are (preferably) non allergenic and have preferably not an unpleasant taste.

Definition and descriptions of how to make both (i) and (ii) now follow:

(i) Surface-Active Waxy Fibres

The first class of fibre material are surface-active waxy fibres.

The fibres used in the present invention are made of a food-grade wax. A wax is a non-glyceride lipid substance having the following characteristic properties:
plastic (malleable) at normal ambient temperatures;
a melting point above approximately 45° C. (which differentiates waxes from fats and oils);
a relatively low viscosity when melted (unlike many plastics);
insoluble in water but soluble in nonpolar organic solvents;
hydrophobic.

Waxes may be natural or artificial, but natural waxes, are preferred. Beeswax, carnauba (a vegetable wax) and paraffin (a mineral wax) are commonly encountered waxes which occur naturally. Some artificial materials that exhibit similar properties are also described as wax or waxy.

Chemically speaking, a wax may be an ester of ethylene glycol (ethane-1,2-diol) and two fatty acids, as opposed to a fats which are esters of glycerine (propane 1,2,3-triol) and three fatty acids. It may also be a combination of other fatty alcohols with fatty acids. It is a type of lipid.

The waxy fibres with the required surface-active properties are produced according to the following method:

The process comprises the steps of selecting a waxy material, dissolving it in a first solvent, mixing the solution of the waxy material in the first solvent with a second solvent having an appropriate viscosity, whereby the second solvent is miscible with the first solvent and the waxy material is not soluble in the second solvent, while continuously introducing shear stress, to form a dispersed phase of elongated wax solution droplets which solidify due to dissolution of the first solvent into the second solvent, to form fibres having a contact angle at the air/water interface or the oil/water interface between 60° and 120°.

In this process, small particles are made from waxy materials to form fibres having a contact angle at an air/water interface between 60° and 120° for stabilisation of foams, or having a contact angle at an oil/water interface between 60° and 120° for stabilisation of emulsions. The oil in the oil/water interface is any triglyceride oil, such as palm oil. Up to now waxy materials have not been used for preparation of micro particulate fibre materials.

Examples of a suitable source for the waxy material are the food-grade waxes carnauba wax, shellac wax or bee wax. This food-grade waxy material can be transformed into micro-particulate fibres by inducing precipitation of a wax solution via solvent change under shear. For instance, the food-grade waxy material is dissolved in high concentration in ethanol and a small amount of this solution is added to a viscous liquid medium and subjected to shearing. This procedure results in the emulsification of the wax solution in the viscous medium, the shear driven elongation of the emulsion drops their successive solidification into rod-like particles due to escape of ethanol into continuous liquid medium, which is assisted by the fact that ethanol is soluble in the liquid medium, while the waxy material is not or poorly soluble therein. After the fibres have been formed they can be extracted and purified by using the natural buoyancy of the wax. In order to facilitate this process the viscosity of continuous liquid phase should be decreased. The inclusion of water effectively thins the solution so that the rods will rise much quicker and a clear separation is seen between the rods and most of the solution. The liquid phase can then be taken and replaced by water several times in order to remove all solvents other than water. Due the fact that waxy materials have a contact angle at an air-water interface or at an oil/water interface between 60° and 120°, the micro particulate fibres have affinity for adsorbing at air/water or oil/water surfaces. Therefore, dispersions containing fibres made from food-grade waxy materials can be used for the stabilisation of foams and emulsions, without need to add other surface-active materials as surfactants, proteins or di-block co-polymers such as Pluronics, as discussed above.

If the contact angle is not already in the specified range of between 60° and 120°, the material may optionally be modified so as to give it the correct contact angle between 60° and 120°. The modification of the fibres can be achieved by chemical and/or physical means. Chemical modification involves esterification or etherification, by means of hydrophobic groups, such like stearate and ethoxy groups, using well-known techniques. Physical modification includes coating of the fibres with hydrophobic materials, for example ethylcellulose or hydroxypropyl-cellulose. Fat and fatty acids such as stearic acid may also be used. The coating can be done using colloidal precipitation using solvent or temperature change, for instance. The physical modification may also involve “decoration” of rod like materials using hydrophobic nano-particles, for instance silica. The parameters that affect the formation of the waxy fibres, are a.o. the viscosity and the composition of continuous liquid phase, the shearing rate, the initial droplet size, the wax concentration into ethanol solution and the total solution volume. Of these, the parameters with noticeable affects were changes to the stirring media and to the concentration of wax in ethanol. Changes to the standard solvent ratio resulted in greater or lesser shear which had a limited effect on the size of the rods produced. A larger influence is held by the type of solvent used. The inclusion of a small amount of ethanol to the viscous stirring media resulted in shorter but better defined micro rods with much lower flaking. It is thought that the inclusion of ethanol in the stirring media may slow the rate of precipitation of waxy material resulting in smaller micro emulsion droplets, thus giving shorter micro rods. For the influence of the various parameters that affect the formation of the waxy fibres, reference is made to WO-A-06/007393 (North Carolina State University).

(ii) Surface-Active Non-Waxy Fibres

The second class of fibre material are surface-active non-waxy fibres. By this, we mean all fibres which do not fall under the definition of waxy fibres.

The non-waxy fibres are usually modified so that they show surface active properties and a contact angle between 60° and 120°. The fibres may be of organic or inorganic origin. In particular, organic, natural fibres made of a crystalline, insoluble form of carbohydrates, such as microcrystalline cellulose, can be used. Such fibres have the advantage that they are very biodegradable, which is favourable for the environment. Very often organic fibres are also food-grade. One example of a suitable source is the microcrystalline cellulose obtainable from Acetobacter. Other examples are fibres, onion fibres, tomato fibres, cotton fibres, silk, stearic acid, their derivatives and copolymers, and other polymers that can be spun with diameter ranging from 0.01 to 30 micrometers.

Examples of inorganic fibres are calcium based fibres (such as CaCO₃, CaSO₄), ZnO, TiO₂, MgO, MgSO₄, Mg(OH)₂, Mg₂B₂O₅, aluminium borate, potassium titanate, barium titanate, hydroxyapatite, attapulgite, but other inorganic crystals with fibre-like morphology could also be used. Preferred inorganic fibres are CaCO₃ fibres.

The fibres used in the present invention are usually modified before use in order to provide the fibre with surface active properties. As a consequence of the modification, the contact angle is modified such that is in the range of between 60° and 120°, preferably between 70° and 110°, more preferably between 80° and 100°. By contact angle we mean the three-phase contact angle at a fibre/air/water interface or at a fibre/oil/water interface, depending on the type product in which the surface-active material of the present invention is used. For foams this will be the fibre/air/water contact angle, for emulsions, the fibre/oil/water contact angle. This can be measured as previously described.

The modification of the fibres can be achieved by chemical and/or physical means. The chemical modification involves esterification or etherification, by means of hydrophobic groups, such as stearate and ethoxy groups, using well-known techniques. The physical modification includes coating of the fibres with hydrophobic materials, for example ethylcellulose or hydroxypropyl-cellulose. One can also use waxes, such as shellac, carnauba or bees wax. Fat and fatty acids such as stearic acid may also be used. The coating can be done using colloidal precipitation using solvent or temperature change, for instance. The physical modification may also involve “decoration” of rod like materials using hydrophobic nano-particles, for instance silica.

One can use the process of controlled esterification of Microcrystalline cellulose (Antova et. al, Carbohyd. Polym., 2004, 57 (2), 131) as possible route for controlled hydrophobicity modification and therefore obtaining particles with surface-active properties.

One may also choose to modify the fibres by more than one means in order to produce a surface active fibre. For example, chemically altering the fibre followed by physical modification. Chemical and/or physical means to modify the fibres must be food grade.

Based on this principle, it will be understood that the skilled person can easily find other routes to modify the hydrophobicity of other types of fibres of organic or inorganic origin.

It has been found that the shape and size are of critical importance for the colloidal stability of foams and emulsions. Rod-like (fibril) shapes are much more efficient then spherical particles. Another key factor for good foam and emulsion stabilisation is the particle contact angle at oil/water or air/water interface, which must be as close to 90° as possible. The rod-like structures must therefore be amphipathic in design (o/w and w/o stabilisation depends on the relative balance between hydrophobicity and hydrophilicity).

The surface active fibres can also be obtained by a self assembly process. In such a case, the surface properties of the fibre material are chosen such that attractive interaction with the surface active particle, either occurs naturally (i.e. it is intrinsic property of both particles and fiber, for instance they can form H-bond) or is enabled in order to promote self-assembly of the fibres with the surface active particles by carefully adjusting the forces acting between the particle, which could be achieved by person skilled in the areas of physical-chemistry, chemical physics colloidal science, material science or nano technology.

Therefore a further aspect of the present invention is a process for production of a frozen aerated product, comprising the steps of:
(a) preparing an aqueous dispersion comprising surface-active particles,
(b) adding fibres to said dispersion in the form of a dry powder or an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam and
(d) freezing the obtained foam.

The necessary ingredients for producing a specific type of aerated food product may be added to the mixture after aeration, if required. An initial freezing step may also be implemented before further ingredients are added and the product is cooled to the storage temperature. For example, the aerated mixture may be frozen to about −5° C., then other ingredients mixed, and the product subsequently stored at −10° C. or below, more typically below −18° C.

Therefore a further aspect of the present invention is a process for production of a frozen aerated product, comprising the steps of:
(a) preparing an aqueous dispersion comprising fibres,
(b) adding surface-active particles to said dispersion in the dry form or as an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam and
(d) freezing the obtained foam.

Therefore a further aspect of the present invention is a process for production of a frozen aerated product, comprising the steps of:
(a) preparing an aqueous dispersion comprising surface-active particles and fibres,
(b) incorporating air into and homogenising the obtained mixture, whereby the fibres assemble with the surface-active particles in situ at the air-water interface, due to attractive interaction between the surface-active particles and the fibres to form a stable foam and
(c) freezing the obtained foam.

Frozen aerated food products include frozen confections such as ice cream, milk ice, frozen yoghurt, sherbet, slushes, frozen custard, water ice, sorbet, granitas and frozen purees.

The term “aerated” means that gas has been intentionally incorporated into the product, such as by mechanical means. The gas can be any food-grade gas such as air, nitrogen or carbon dioxide. The extent of aeration is typically defined in terms of “overrun”. In the context of the present invention, % overrun is defined in volume terms as: ((volume of the final aerated product-volume of the mix)/volume of the mix)×100.

The amount of overrun present in the product will vary depending on the desired product characteristics.

A frozen aerated food product according to the present invention has an overrun of more than 30%, preferably more than 50%, more preferably more than 75%. Equally preferably a frozen aerated confection has an overrun of less than 200%, more preferably less than 150%, most preferably less than 120%.

The frozen aerated food product may comprise any further ingredient, which is commonly used in a frozen aerated food product. Such ingredients comprise fats/oils; proteins (milk proteins, soy proteins): sugars, such as sucrose, fructose, dextrose, lactose, corn syrups, sugar alcohols; salts; colours and flavours; fruit or vegetable purees, extracts, pieces or juice; stabilisers or thickeners, such as polysaccharides, e.g. locust bean gum, guar gum, carrageenan, microcrystalline cellulose; and inclusions such as chocolate, caramel, fudge, biscuit or nuts.

The fibres can be added to any known frozen aerated food product. It is clear that they should be food grade.

A typical ice cream in the light of the present invention comprises typically ice cream contains 0.5-18 wt-% fat (preferably 2-12 wt-%), 0.5-15 wt-% milk solids not fat (MSNF, which contains casein micelles, whey proteins and lactose), 10-30 wt-% sugars, 40-75 wt-% of water, 0.001-10 wt-% of the fibres as describes above and the rest are other ingredients such as stabilisers, further emulsifiers and flavourings. All wt-% are based on the total weight of the ice cream.

A preferred embodiment is an ice cream, which comprises liquid oil or a mixture of liquid oils. As mentioned above liquid oils in the context of the present invention means that it 50% of the oil is liquid at the consumption temperature.

Further embodiments of the present invention are premixes of frozen aerated food products. Such compositions include liquid premixes, for example premixes used in the production of frozen confectionery products, and dry mixes, for example powders, to which an aqueous liquid, such as milk or water, is added prior to or during aeration.

A further embodiment of the present invention relates to a process for the preparation of a frozen aerated food product as described above.

Typically, a frozen aerated product stabilised by surface active particles can be produced by the using the following process steps.

(i) Produce an aqueous dispersion of surface active fibres, as previously described.
(ii) To this aqueous dispersion of surface active fibres, sugars, sugar alcohols, and corn syrups may be added. However, addition of other surface active agents (e.g. proteins, surfactants) should preferably be avoided at this stage.
(iii) The aqueous dispersion of surface active fibres is then aerated. Mechanical means of aerating mixes are well known to those skilled in the art, and include: hand held kitchen blenders, Hobart mixer, Kenwood mixer, Oakes mixer, and scraped surface heat exchangers.

At this stage, and before mixing with other ingredients, the aerated mix may then be stored in order to let the water phase drain through the foam. This leads to the formation of a foam layer of increased air phase volume on top of an aqueous phase depleted of air bubbles. The aqueous phase may then be separated from the foam phase before the foam is mixed with other ingredients. This method allows a product of a greater air phase volume (or overrun) to be achieved when mixing the foam with the other ingredients since the drained foam will consist of a greater air volume per unit mass.

(iv) For quiescently frozen aerated products, the remaining ingredients are then added to the aerated mix. Typically they are added in liquid form, i.e. dissolved or dispersed in water. However, ingredients may also be added in solid form, e.g. inclusions such as nuts, chocolate pieces, fudge, and fruit. The aerated mix is subsequently quiescently frozen without the presence of mechanical shear. Quiescent freezing may be achieved through several means including: freezing in a domestic freezer, in a cold room, in liquid nitrogen, on solid carbon dioxide, or in a brine bath.
(vi) For shear frozen aerated products, the aerated mix produced in (iii) is then shear frozen. This can be achieved using, for example, a scrape surface heat exchanger or a domestic ice cream freezer. The remaining ingredients which constitute the product may be added before shear freezing or after shear freezing. Before shear freezing, preferably the aerated mix contains one or more freezing point depressant such as one or more sugars, sugar alcohols, corn syrups, or salts. For a frozen product such as a sorbet or ice cream, then preferably the amount of sugars present before shear freezing will be at least 15% by weight. Typically, a product is shear frozen to between about −4° C. and −15° C., after which the product is then tempered to the final storage or consumption temperature.

Using fibres as described above it is possible to obtain overruns of 400% or more. This is advantageous, because it allows creating various designs of frozen aerated food products

Therefore a further embodiment of the present invention relates to a process for the preparation of a frozen aerated food product as defined above, wherein
(i) the surface active fibres are aerated in water, in which the aqueous phase can optionally comprise dispersed sugars
(ii) the aerated solution is then mixed with the remaining ingredients that constitute of the food product
(iii) the aerated food product is then quiescently frozen.

A further embodiment of the present invention relates to a process for the preparation of a frozen aerated food product as defined above, wherein
(i) the surface active fibres are aerated in water, in which the aqueous phase can optionally comprise dispersed sugars
(ii) the aerated solution having an overrun of at least 400% is then mixed with the remaining ingredients that constitute of the food product
(iii) the aerated food product is then quiescently frozen.

Therefore the invention also relates to a process for production of a frozen aerated product as described above comprising the steps of:
(a) preparing an aqueous dispersion comprising surface-active particles,
(b) adding fibres to said dispersion in the form of a dry powder or an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam, and
(d) freezing the obtained foam.

Therefore the invention also relates to a process for production of a frozen aerated product as described above comprising the steps of:
(a) preparing an aqueous dispersion comprising fibres,
(b) adding surface-active particles to said dispersion in the form of a dry powder or an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam, and
(d) freezing the obtained foam.

Therefore the invention also relates to a process for production of a frozen aerated product as described above comprising the steps of:
(a) preparing an aqueous dispersion comprising fibres and surface active particles,
(b) incorporating air into and homogenising the obtained mixture, whereby the fibres assemble with the surface-active particles in situ at the air-water interface, due to attractive interaction between the surface-active particles and the fibres to form a stable foam, and
(c) freezing the obtained foam.

As stated above already it is also possible to carry out the freezing step quite sometime after the foaming step. That means that the freezing step can be carried out even at another location than the rest of the production steps. The prefrozen product is stable.

### DESCRIPTION OF THE FIGURES

FIG. 1: Images of aerated products A to D after 12 days storage at 5° C. The black line on the sample vial indicates the height of the foamed product in the vial at time=0 days, i.e. immediately after pouring into the vial. In each case, the bubbles remain stable after the storage period, i.e. very little observable bubble growth and foam collapse.

FIG. 2: Images of comparative examples (A, B, and C) after 2 hours and storage at 5° C.

FIG. 3: Images of comparative examples (A, B, and C) after 8 days and storage at 5° C. In each case, after storage, significant bubble growth has taken place, where the bubbles are clearly visible to the observer. Furthermore, particularly for B and C, the foam has lost significant volume, i.e. collapsed.

FIG. 4: SEM images of Fresh and Abused samples of product A. Images are shown at ×25, ×50, and ×100 magnification.

FIG. 5: SEM images of Fresh and Abused samples of product D. Images are shown at ×25, ×50, and ×100 magnification.

FIG. 6: SEM images of Fresh and Abused samples of product B. Images are shown at ×25, ×50, and ×100 magnification.

FIG. 7: SEM micrographs of Comparative Example Mix B. (Left) Fresh samples. (Right) Samples after temperature abuse. Magnifications ×25 (above) and ×100 (below).

FIG. 8: SEM micrographs of Comparative Product B comprising MCC. (Left) Fresh samples. (Right) Samples after temperature abuse. Magnifications ×25 (above) and ×100 (below).

FIG. 9: SEM micrographs of Comparative Example Mix D. (Left) Fresh samples. (Right) Samples after temperature abuse. Magnification ×25.

FIG. 10: SEM micrographs of aerated frozen sorbets after temperature abuse. (Above) Air phase stabilised using surface active fibres MCC and EC. (Below) Air phase stabilised using milk protein (Hygel) in the absence of surface active fibres. Magnifications used were ×25 and ×100.

FIG. 11: SEM micrographs of aerated and frozen Mix F, comprising surface active fibres MCC and EC after temperature abuse. Magnifications: Left ×25. Right ×50.

The invention will now be further illustrated by means of the following non-limiting examples.

### EXAMPLES

### Materials

TABLE 2
Summary of ingredients used and supplier details.

| Ingredient | Supplier | Comments |
|---|---|---|
| Shellac Wax | Supplied by NB | |
| | Entrepreneurs | |
| Glycerol | Alfa Aesar | 99+% |
| Ethanol | Fischer Scientific | |
| Ethylene Glycol | Fischer Scientific | |
| Ethyl cellulose (EC) | Sigma-Aldrich, UK | Viscosity 100 cps in |
| | | 80%/20% toluene/ethanol |
| Microcrystalline Cellulose | Cotton based, hydrolysed by | Prepared as described in |
| (MCC) | sulphuric acid | Example 1 |
| CaCO₃ | Qinghaui Haixing Science | |
| | and Technology | |
| | Development Co., Ltd, | |
| | China | |
| ZnO | Chengdu Advanced | |
| | Technologies and Crystal- | |
| | Wide Co., Ltd, China | |
| Skim Milk Powder (SMP) | United Milk, UK | 33-36% protein, 0.8% fat, |
| | | 3.7% moisture. |
| Sucrose | Tate and Lyle, UK | Granulated sugar |
| Xanthan Gum | CP Kelco | Keltrol RD cold |
| | | dispersible |
| Coconut Oil (CNO) | Van den Bergh Oils Ltd, | Refined Coconut Oil |
| | Purfleet, UK | |
| Sunflower Oil (SFO) | Leon Frenkel Ltd, | |
| | Belvedere, UK | |
| Hygel | Kerry Biosciences | Hydrolysed protein. |
| Cornsyrup (LF9) | Cerestar, UK | C*Sweet F017Y4 |
| | | Glucose-Fructose Syrup, |
| | | Fructose content 9%, dry |
| | | substance 78%. |
| Locust Bean Gum (LBG) | Danisco Ingredients | Type 246 |
| Guar Gum | Willy Beneke, Germany | Type 2463 |
| Strawberry Puree | SVZ International BV, The | Brix 6.4-9.0, |
| | Netherlands | pH 3.4-3.8, |
| | | viscosity 600-900 mPas |
| Citric acid | Jungbungzlaver, Austria | |

Before use, the shellac wax was purified by dissolving the wax in boiling ethanol with removal of insoluble materials via centrifugation. The ethanol was then removed under vacuum with gentle heating yielding the purified shellac crystals.

Scanning electron microscopy images are made according to the following method: 5 mm×5 mm×10 mm blocks were cut from a −80° C. cooled sub sample of ice cream using a pre cooled scalpel. After mounting on to an SEM stub using OCT on the point of freezing and immediately plunging in to nitrogen slush, samples were transferred to an Alto 2500 low temperature preparation chamber for fracture (−90° C.), etching (10 seconds) and coating (2 nm Au/Pd). Examination was carried out using a Jeol 6301F scanning electron microscope fitted with a Gatan cold stage at −150° C.

### Preparation of the Basic Foams: Examples 1-9

### Example 1

### MCC-EC Complex Formed by In-Situ Interaction

15 g of absorbent cotton (shanghai pharmaceutical group product) was dispersed into 150 ml of 50% (V/V) sulfuric acid in a 400 ml beaker. Subsequently the beaker was put into a water bath with the temperature of 30 C. The hydrolysis will last for 6.5 hours with continuous magnetic stirring. The resultant mixture was cooled down and diluted by 850 ml of deionized water. After 24 hours, microcrystalline cellulose (MCC) fibres would settle down to the bottom of beaker, and the supernatant was removed and replaced by the same volume of deionized water. This purification process was repeated for 5 times. Then the MCC suspension was transferred into a dialysis tube to remove the acid and impurities completely by dialyzing in water. This procedure was repeated for several times until the pH value of the water in the MCC dispersion was neutral (pH˜6). The MCC suspension was further diluted to 4% (weight concentration) and was put into a freeze dryer. The dry MCC powders were obtained after 48 hours and the yield is about 20%.

0.1 g ethyl cellulose (EC, 100 cps, ethoxyl content 48%, Aldrich) powder was dissolved into 10 ml acetone at 30° C. in a 50 ml beaker. Subsequently, the equal volume of water was quickly added into the EC solution under strong stirring to precipitate the EC into particles. The acetone was then removed by using a rotary evaporator and water was added to set the final volume to 10 ml. Finally, 0.1 g dry MCC powder prepared by previous mentioned process was added into EC dispersion. The MCC-EC dispersion was stirred for 10 min, sonicated for 10 min, and stirred for another 10 min. The resulting dispersion was transferred into a 25 ml cylinder and was shake by hand to produce foam. The overrun of the foam would reach 120% and the foam was stable for at least 3 months.

### Example 2

4.0 g mica (SCI-351, 10˜100 μm, Shanghai Zhuerna High-tech Powder Materials Co., Ltd. China) was dispersed in 40 ml acetone solution containing 0.2 g ethyl cellulose (EC, 10 cps, ethoxyl content 48%, Aldrich). After 5 minutes sonication, 160 ml deionised water was quickly added into the dispersion under strong stirring. 5 minutes later, most of EC particles precipitated out from acetone and deposited onto the surface of mica. After filtration and aging in 80° C. vacuum oven for 4 hours, Mica was successfully modified by ethyl cellulose.

The modified mica showed good foamability and foam stability. 0.5 g modified mica was dispersed in 10 ml water containing 0.75 wt % ethanol, and then the dispersion was transferred to 25 ml cylinder. The overrun reached 25% after strong shaking by hand for 30 seconds. One week later, the foam still remained stable.

Functional CaCO3 rods could be used to improve the foam ability and foam stability of modified mica. CaCO3 rods (Qinghai Haixing Science & Technology Co., Ltd. China) were modified by oleoyl chloride to adjust their wettability from highly hydrophilic to intermediate hydrophobic. CaCO3 rods were dried in 160° C. oven for 4 hours to remove adsorbed water. Acetone was also dried by 4 A molecular sieve desiccant. 10 ml oleoyl chloride (85%, Aldrich) was diluted by 90 ml dried acetone to get 10% (V/V) oleoyl chloride solution. 5.0 g CaCO3 rods was dispersed into 100 ml treated acetone. After 10 minutes sonication, 3.0 ml oleoyl chloride solution was dropped into the dispersion under stirring. 1 hour later, the dispersion was filtrated and washed three times by ethanol (Re-dispersing filter cake into 30 ml ethanol, stirring for 5 minutes). After washing, the filter cake was dispersed into 30 ml ethanol, and then 120 ml water was added into the dispersion under strong stirring. Half an hour later, the dispersion was filtrated and washed three times by water (Re-dispersing the cake into 60 ml water, stirring for 10 minutes). After washing and filtration; we weighed the filter cake and added certain water to get 50 w % CaCO3 slurry.

When we mixed 0.5 g modified mica and 1.0 g functional CaCO3 slurry with 10 ml water containing 0.75 wt % ethanol, the overrun could reach 100% after strong shaking by hand for 30 seconds. The foam also showed much better foam stability than modified mica, and was stable for at least 2 months.

### Example 3

Shellac rods were precipitated by dropping droplets containing 50% wt shellac in ethanol into 40 ml solution consisting of 60:30:10 glycerol/ethylene glycol/ethanol stirred at speed 5.7 on an IK A RH KT/C magnetic stirrer/hotplate. 170 μl of 50% wt shellac solution in ethanol was added in 10 μl increments to the viscous stirring media, which equates to 0.085 g of wax. After dropping has been finished the total solution was stirred for 10 additional minutes to insure solidification of the fibre. The waxy micro rods prepared as described above were extracted and purified by using the natural buoyancy of the wax: 40 ml solution containing waxy fibres as described above was transferred into three sample tubes (75 mm×25 mm), with washings (milli-Q), and then topped up with milli-Q water till ¾ full. The tubes were then inverted, but not shaken, several times in order to mix the solvents. The inclusion of water effectively thinned the solution so that the rods would rise much quicker and a clear separation was seen between the rods and most of the solution. The liquid phase can then be taken and replaced by water several times in order to remove all solvents other than water, finally the rods can be re-dispersed in a known volume of water thus giving a solution with an approximate concentration of rods. The concentration is approximate due to the fact that in the cleaning and separating process some rods will be lost; this is estimated to be of the order of 5% of the initial weight of wax solution dropped into the stirring liquid. Thus, when cleaned and re-dispersed in 20 ml of water in a sample tube, with an approximate 5% loss, gave a 0.4% wt concentration of shellac fibres in water with average length of 120 μm and diameter of 2 μm. When the solution is manually shaken for 30 sec it produces a foam that is stable for more then one week. Using confocal microscopy, a dense network of shellac fibres could be clearly seen on the bubble surface.

### Example 4

Shellac rods were precipitated from 17.5% wt shellac in ethanol into 40 ml of 60:30:10 glycerol/ethylene glycol/ethanol and stirred at speed 5.7 on an IK A RH KT/C magnetic stirrer/hotplate: 480 μl of 17.5% wt shellac solution was added in 10 μl increments to the viscous stirring media, this again equates to 0.084 g of wax. When cleaned and re-dispersed in 20 ml of water in a sample tube, with an approximate 5% loss, gave a 0.4% wt concentration of shellac in water. The rod length produced using this method was 30 μm on average. When the solution is manually shaken for 30 sec it produces a foam that is stable for more then one week. Using confocal microscopy, a dense network of shellac fibres could be clearly seen on the bubble surface.

### Example 5

Three separate concentrations of rods in milli-Q water were produced, 0.5% wt, 1.2% wt and 2.0% wt. They were produced in the same way as in example 3 except for the amount of shellac added, also the solutions were now in 10 ml measuring cylinders, so that foam volume can be measured directly, and the rods needed to be in 4 ml of water. However, during the cleaning process the rods are never completely out of solution and so this provides a problem with having an accurate volume of water in the final dispersion. To overcome this problem the volume of water is deduced by weight. The measuring cylinder is weighed when empty and then the wet rods are transferred to the cylinder along with washings, the cylinder is then weighed again and water is added until the final weight is 4 g, plus the weight of the wax, more than the empty measuring cylinder. Thus there is 4 ml of milli-Q water in the dispersion. Dispersions with three different concentrations of shellac fibres were prepared as described above using following conditions and concentrations:
0.5% wt-110 μl in 10 μl increments of the 20% wt shellac in ethanol was pippetted into a 40 ml stirring solution of 85:15 glycerol/water at speed 6.0.
1.2% wt-250 μl in 10 μl increments of the 20% wt shellac in ethanol was pippetted into a 40 ml stirring solution of 85:15 glycerol/water at speed 6.0.
2.0% wt-420 μl in 10 μl increments of the 20% wt shellac in ethanol was pippetted into a 40 ml stirring solution of 85:15 glycerol/water at speed 6.0.

All rod dispersions were cleaned and separated and finally transferred as previously stated. The resulting dispersions were shaken as before, 30 secs using manual shaking. Resulting foams were measured in mls and monitored at the same time intervals as before, 0 h, 1 h, 2 h, 5 h, 24 h, 48 h, 72 h, 96 h, 120 h, 144 h, and 168 h. For all foams produced, the most rapid reduction in foam volume was observed in the first 5 hours, which is manly due to liquid drainage, after which a near plateau in stability is observed for at more then 7 days. Furthermore, it was found that there is an approximately linear relationship between the concentration of the rods in solution and the volume of foam produced.

### Example 6

In a 50-ml beaker, 0.05 g ethyl cellulose (EC, Aldrich product, viscosity: 10 cps) was added into 20 ml of acetone. Then under ultrasonication (Branson Ultrasonics Corporation, 5510E-DTH) and magnetic stirring (IKA, RCT basic), the ethyl cellulose gradually dissolved to form a homogenous solution. Next 0.2 g of Microcrystalline cellulose (MCC, rod-like, Diameter: ˜20 nm, Length: several to tens of microns) was added into the system and ultrasonication was applied for 10 minutes to induce the homogenous dispersion of the MCC. As a non-solvent of ethyl cellulose, 10 ml of water was dropped into the above system to induce coacervation of ethyl cellulose, during which the coacervated ethyl cellulose particles were attached to MCC fibers. Subsequently, the acetone was completely removed by stirring or under reduced pressure at an elevated temperature. The obtained MCC/ethyl cellulose water dispersion was used to investigate the foamability and foam stability. The foams were prepared at room temperature by hand-shaking for a period of 40 s. The foams stabilized by this material are stable at ambient conditions for more than two weeks.

### Example 7

200 g of a 1 wt % ethyl cellulose (EC) solution was prepared in acetone. To this solution, 200 g of water was added with stirring. After 10 minutes further stirring, the acetone was removed by evaporation using a rotary evaporator. After about 1 hour rotary evaporation, the remaining mass was then determined and water added in order to adjust the concentration of ethyl cellulose in water to 1 wt %. Microcrystalline cellulose (MCC, prepared as described in Example 1) powder was then added to a concentration of 1 wt % in this solution. The solution was then stirred for 10 minutes, followed by sonication in an ultrasound bath for 10 minutes, and a further 10 minutes of stirring. 200 g of the above prepared aqueous MCC/EC dispersion was aerated using a Hobart Mixer (Hobart Corporation, Model N50CE, set at speed setting 3) for approximately 5 minutes. The foam was then transferred to a plastic beaker and left for 18 hours at 5° C. in order to let the water drain from the bulk foam. The foam was stored at 5° C. until further use.

### Example 8

4.0 g of rod-like CaCO₃ (provided by Qinghai Haixing Science and Technology Development Co., Ltd, China, Diameter: ˜2 microns, Length: ˜50 microns) was dispersed into 40 ml acetone solution containing 0.20 g of ethyl cellulose (EC, Aldrich product, viscosity: 10 cps). Ultrasonication (Branson Ultrasonics Corporation, 5510E-DTH) was used for 10 minutes to induce the homogenous dispersion of the CaCO₃. Then 160 ml of water was quickly poured into the dispersion to make the ethyl cellulose deposit fast on the surface of CaCO₃ particles. After magnetic stirring (IKA, RCT basic) for 2 minutes, the dispersion was filtrated, and the filter cake was immediately dried in vacuum oven at 80° C. Finally CaCO₃/ethyl cellulose composite was obtained. Then the powder was put into water to investigate foamability and foam stability. The foams were prepared at room temperature by hand-shaking for a period of 40 s. The foams stabilized by these materials are stable for more then one month. The initial volume of the foam linearly increased with the amount of material added. It is interesting to note that initial foam volume of the foams stabilized by these materials passes trough a maximum at a ratio of EC:CaCO₃ of about 1:20 (which was chosen in this example).

### Example 9

4.0 g of rod-like ZnO (tetrapod-like, provided by Chengdu Advanced Technologies and Crystal-Wide Co., Ltd, China, Diameter: ˜2 microns, Length: several tens of micron) was dispersed into 40 ml of acetone solution containing 0.20 g of ethyl cellulose (EC, Aldrich product, viscosity: 10 cps). Ultrasonication (Branson Ultrasonics Corporation, 5510E-DTH) was used for 10 minutes to induce the homogenous dispersion of the ZnO. Then 160 ml of water was quickly poured into the dispersion to make ethyl cellulose deposit fast on the surface of ZnO particles. After magnetic stirring (IKA, RCT basic) for 2 minutes, the dispersion was filtrated, and the filter cake was immediately dried in vacuum oven at 80° C. Finally, a ZnO/ethyl cellulose composite was obtained. Then the powder was put into water to investigate foamability and foam stability. The foams were prepared at room temperature by hand-shaking for a period of 40 s. The foams stabilized by this material are stable at ambient conditions for more than two weeks.

### Production of Frozen Aerated Food Products:

### Example 10

### Aerated Products, Stable when Statically Frozen

### Materials

All ingredients used to make mixes and aerated products are summarised in Table 2.

### Methods

### Preparation of Base Mixes

Mixes A to D were prepared with the formulations as detailed in Table 3. All mixes were prepared in 500 g batches.

TABLE 3
Ingredients and quantities/wt % used to make Mixes A to D.

| Ingredient | Mix A/wt % | Mix B/wt % | Mix C/wt % | Mix D/wt % |
|---|---|---|---|---|
| Sucrose | 25 | 25 | 25 | 25 |
| Xanthan | 0.3 | 0.3 | 0.3 | 0.3 |
| SMP | — | 5 | 5 | 5 |
| CNO | — | — | 5 | — |
| SFO | — | — | — | 5 |
| Water | 74.7 | 69.7 | 64.7 | 64.7 |

Mix A was prepared by mixing sucrose and xanthan in stirring water. The solution was then heated to 40° C. and stirring continued for 30 minutes. The solution was then stored at 5° C. until use.

Mix B was prepared by mixing sucrose, skim milk powder, and xanthan in stirring water. The solution was then heated to 40° C. and stirring continued for 30 minutes. The solution was then stored at 5° C. until use.

Mix C was prepared by mixing sucrose, skim milk powder and xanthan in stirring water. The solution was then heated to 60° C. and melted coconut oil was then added with stirring for 5 minutes. The solution was then mixed using an IKA Ultraturrax (Model T18 Basic, 24,000 rpm 10 minutes) in order to emulsify the oil phase. Immediately afterwards, the solution was subject to Ultrasonication (Branson digital sonifier, Model 450) and then the solution was cooled by placing in a Glycol bath set to −18° C., and the solution stirred until it reached a temperature below 10° C. The solution was then stored at 5° C. until use.

Mix D was prepared by mixing sucrose, skim milk powder and xanthan in stirring water. The solution was then heated to 6° C. and sunflower oil was then added with stirring for 5 minutes. The solution was then mixed using an IKA Ultraturrax (Model T18 Basic, 24,000 rpm 10 minutes) in order to emulsify the oil phase. Immediately afterwards, the solution was subject to Ultrasonication and then the solution was cooled by placing in a glycol bath set to −18° C., and the solution stirred until it reached a temperature below 10° C. The solution was then stored at 5° C. until use.

Combining Mixes A to D with Foam to Produce Aerated Mixes A to D

A proportion of the foam phase prepared in Example 7 was blended with Mixes A to D in order to produce a foam with approximately between 50 and 100% Overrun. 20 mL of product were then poured glass vials and stored at 5° C. The stability of these foams was determined by visual observation.

The Overrun of the aerated Mixes immediately after aeration was measured to be:

| | |
|---|---|
| Aerated Product A | 73% Overrun |
| Aerated Product B | 75% Overrun |
| Aerated Product C | 74% Overrun |
| Aerated Product D | 78% Overrun |

### Preparation of Static Frozen Aerated Products A to D

A proportion of the foam produced using mixes A to D (prepared as stated above) were poured into ca. 15 mL plastic containers, which were then placed on solid carbon dioxide (Cardice) in order to freeze. After 30 minutes, these were then transferred to a −80° C. freezer. This method of freezing is termed static, or quiescent, freezing since no mechanical shear is involved during the freezing step.

### Comparative Examples for Stability at Chill

Comparative examples were prepared (Comparative Mixes A, B, and C) with similar formulations to Mixes A, B, and D, but without the subsequent addition of MCC/EC foam. Solutions were stored at 5° C. They were then aerated using a Salter Milk Frother (Salter, purchased from amazon.co.uk) until an Overrun of between about 50 and 100% was achieved. 20 mL of product were then poured glass vials and stored at 5° C. The stability of these foams was determined by visual observation.

The Overrun of the aerated Mixes immediately after aeration was measured to be:

| | |
|---|---|
| Comparative Aerated Product A | 91% Overrun |
| Comparative Aerated Product B | 64% Overrun |
| Comparative Aerated Product C | 90% Overrun |

### Air Phase Stability Tests for Static Frozen Foams

Some samples of products (A to D) were stored at −80° C. These are termed “fresh” products.

Some samples of products (A to D) were stored at −10° C. for 1 week, before returning to −80° C. These are termed “temperature abused” products, since they have been subject to a relatively warm temperature. Comparing the bubble size of the air phase between temperature abused and fresh products provides and indication of foam stability.

### Results

### Stability at Chill

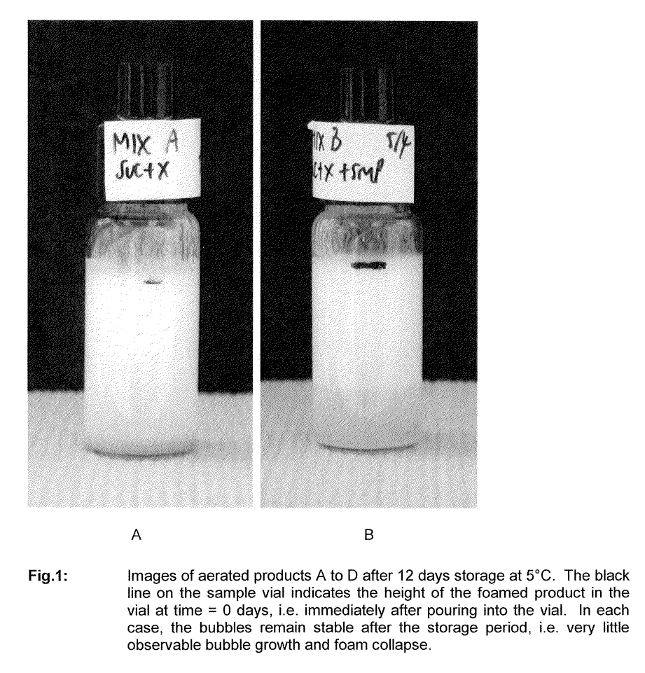

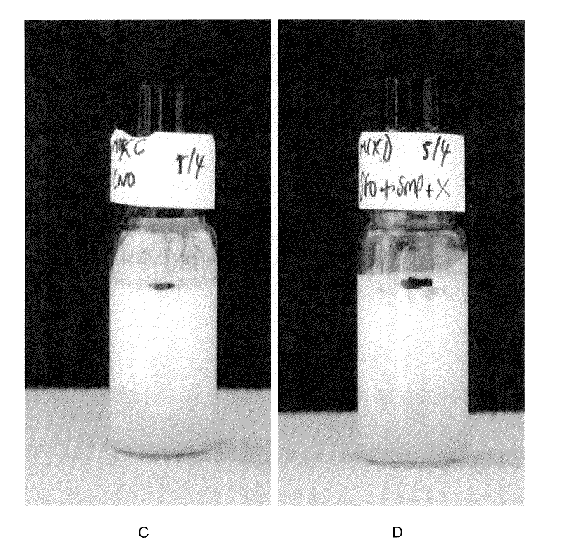

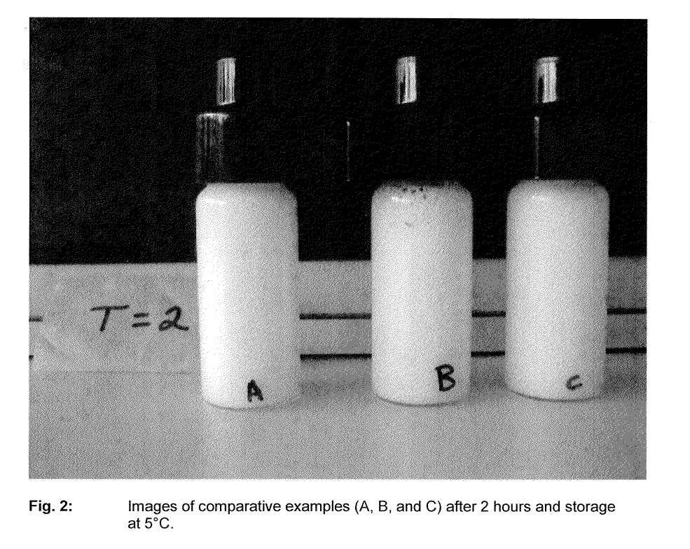

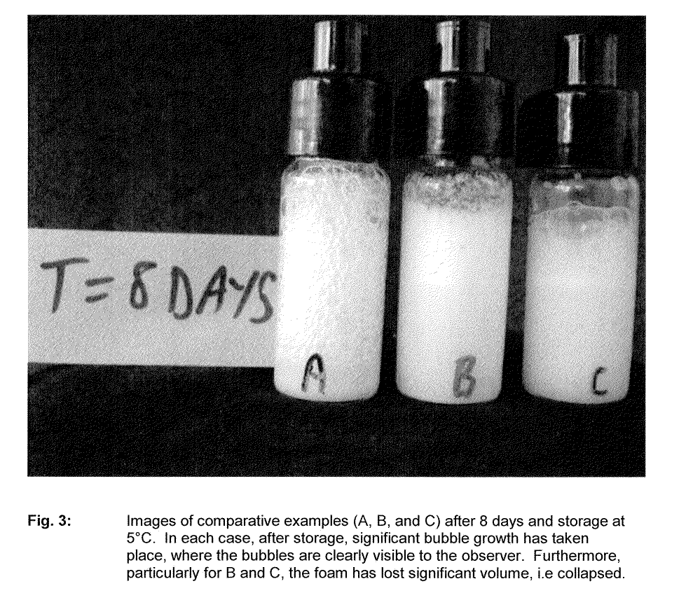

FIG. 1 shows the stability of aerated foams A to D (comprising of MCC/EC surface active fibres) after 12 days storage at 5° C. FIG. 2 and FIG. 3 shows the stability of comparative aerated foams A to C, which are not stabilised by MCC/EC surface active fibres after 2 hours and 8 days storage at 5° C., respectively. These data clearly indicate that the foams stabilised by MCC/EC surface active fibres are significantly more stable at chill than the comparable examples stabilised by milk protein. The comparative foams (FIGS. 2 and 3) show significant bubble growth and some bubble collapse (i.e. unstable) where was the foams stabilised using surface active fibres retain small bubbles and the air phase volume (FIG. 1).

Stability when Frozen

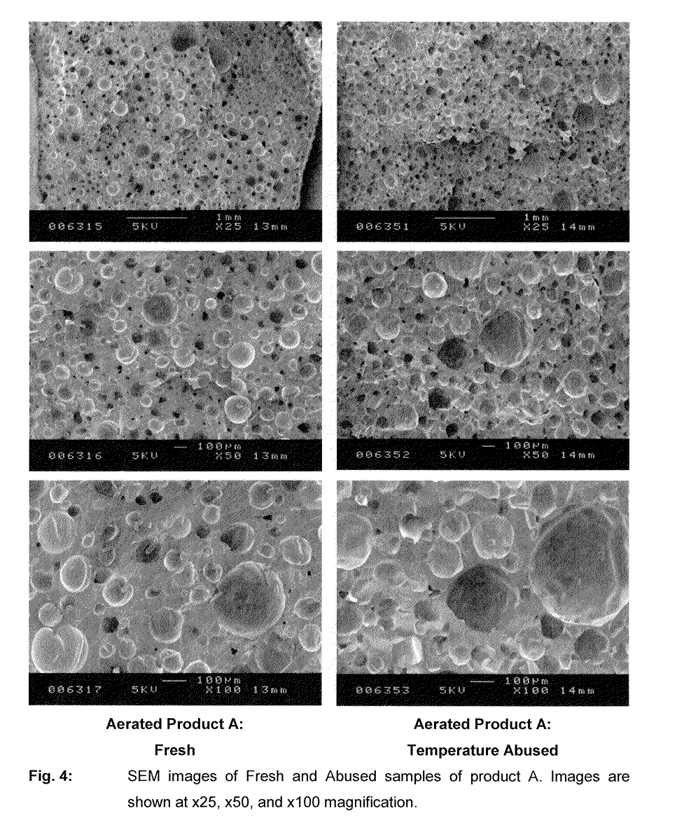

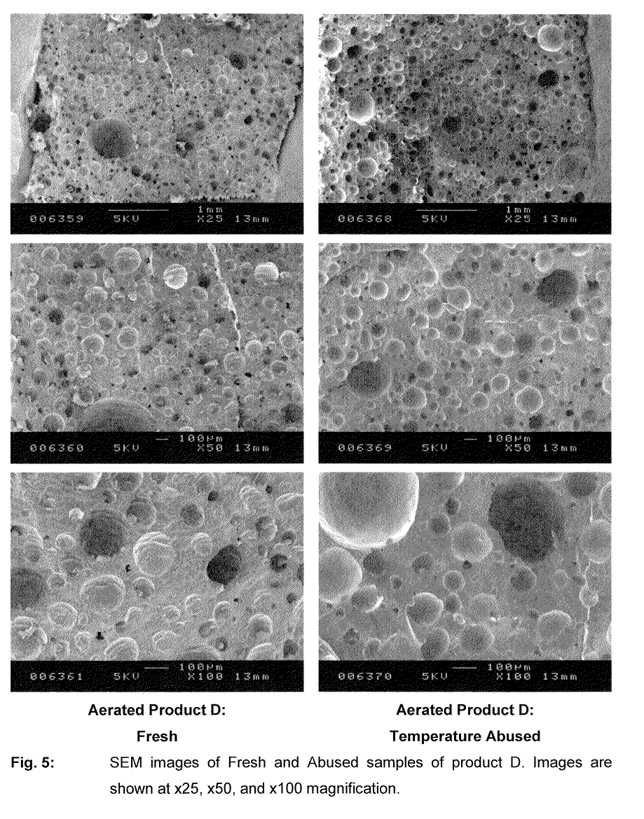

FIGS. 4 and 5 show Scanning Electron Microscope Images of Fresh and Temperature abused samples of A and D, respectively. In the case of both products, when comparing with the fresh sample, there is relatively little change in air cell size when the products are temperature abused.

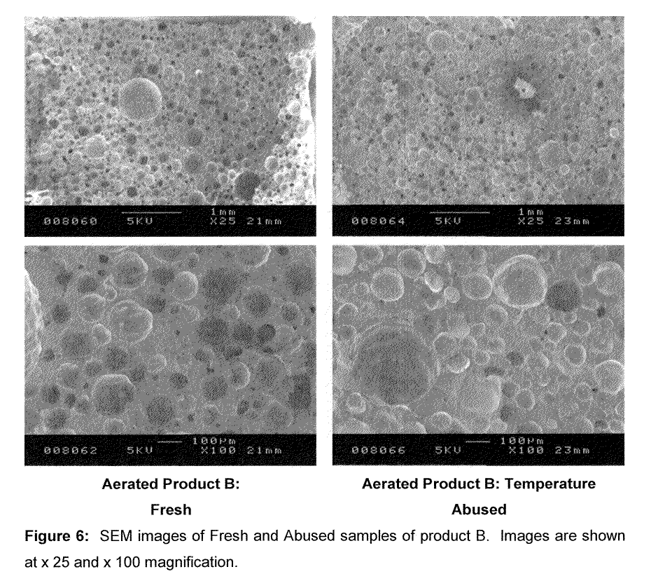

FIG. 6 further shows SEM images of both Fresh and Abused samples of aerated and frozen Mix B, comprising MCC/EC surface active fibres. Again, in his case, there is relatively little change in air cell size distribution when this product is temperature abused. These data demonstrate the ability to produce stable frozen aerated products using surface active fibres as the principal air stabilising ingredient. These can be used as effective aerating agents in both simple formulations (e.g. A—comprising of only sucrose and xanthan) and more complex formulations (e.g. B—comprising milk protein, sugar and xanthan, and D—comprising of sucrose, xanthan, milk protein, and liquid oil).

### Example 11

### Comparative Aerated Products, Statically Frozen

This example describes the production of aerated and statically frozen products that are stabilised without the use of surface active fibres. These examples are for comparison with those in Example 10 which are stabilised using surface active fibres.

### Preparation of Base Mixes

Mixes B and D, prepared with formulations as detailed in Table 4, were made as a base for the comparative examples. These mixes were produced using a similar methodology as described in Example 10.

TABLE 4
Ingredients and quantities/wt % used to make Mixes B and D in order to
prepare comparative aerated product examples.

| Ingredient | Mix B/wt % | Mix D/wt % |
|---|---|---|
| Sucrose | 25 | 25 |
| Xanthan | 0.3 | 0.3 |
| SMP | 5 | 5 |
| SFO | — | 5 |
| Water | 74.7 | 64.7 |

### Preparation of Comparative Aerated Product B, Produced in the Absence of Either MCC or EC

200 g of Mix B was aerated using a Bamix DeLuxe® mixer (Bamix, Switzerland) to an overrun of 105%. A proportion of the foam produced was then poured into plastic containers containing approximately 15-20 mL product. These were then placed on solid carbon dioxide (Cardice) in order to freeze. After 30 minutes, these were then transferred to a −80° C. freezer.

Accordingly, this product can be compared directly with Product B in Example 10, which has a similar formulation except that the air phase is stabilised by surface active fibres (MCC with EC).

### Preparation of Comparative Aerated Product B Comprising Added EC Only

100 g of 1% EC-dispersion, prepared as described in Example 7, was aerated using a Breville mixer, yielding a total volume of 250 ml. Approximately 50 ml of this foam was mixed with 50 g of Mix B. During mixing, bubbles grew rapidly as judged by the unaided eye and the foam collapsed almost immediately. No product was collected for static freezing since almost all of the air phase was lost: the overrun was measured to be less than 20% after mixing.

Therefore, we can conclude that although a 1% solution of ethyl cellulose dispersion is aeratable, the resulting foam is unstable, especially when blended with the other ingredients in the formulation. Using the combination of ethyl cellulose and microcrystalline cellulose surface active fibres, however, the foam is much more stable (Example 10, FIG. 6) than when only ethyl cellulose surface active particles are used; i.e. in this comparative example.

### Preparation of Comparative Aerated Product B Comprising Added MCC Only

1 g of dry MCC was added to 100 ml of Mix B and dispersed by gentle stirring. This mixture was aerated using a Bamix DeLuxe® mixer (Bamix, Switzerland) to an overrun of 124%. A proportion of the foam produced was then poured into plastic containers containing approximately 15-20 mL product. These were then placed on solid carbon dioxide (Cardice) in order to freeze. After 30 minutes, these were then transferred to a −80° C. freezer.

Preparation of Comparative Aerated Product D, Produced in the Absence of Both MCC and EC (i.e. No Surface Active Fibres)

Method A: 200 g of Mix D was aerated using a Bamix DeLuxe® mixer (Bamix, Switzerland). However, an overrun of only 50% was reached, most likely because of the anti-foaming behaviour of the oil present. This experiment indicates that producing a stable aerated product with significant overrun (over 50%) is difficult when liquid oil (e.g. sunflower oil) is present in the mix.

Method B: 5% SMP was dissolved into water and 200 g of this solution was aerated using a Hobart Mixer (Hobart Corporation, Model N50CE, set at speed setting 3) for approximately 5 minutes. A proportion of this foam phase was blended with Mix D in order to produce a foam with approximately 126% Overrun. A proportion of the foam produced was then poured into plastic containers containing approximately 15-20 mL product. These were then placed on solid carbon dioxide (Cardice) in order to freeze. After 30 minutes, these were then transferred to a −80° C. freezer.

Accordingly, this product can be compared directly with Product D in Example 10, which has a similar formulation except that in the case of Example 10, the air phase is stabilised by surface active fibres (MCC with EC).

### Air Phase Stability Tests for Comparative Frozen Examples

Storage of aerated products was performed as described in Example 10. Samples were prepared both “fresh” and “temperature abused”, for subsequent analysis of air phase stability using Scanning Electron Microscopy.

### Results

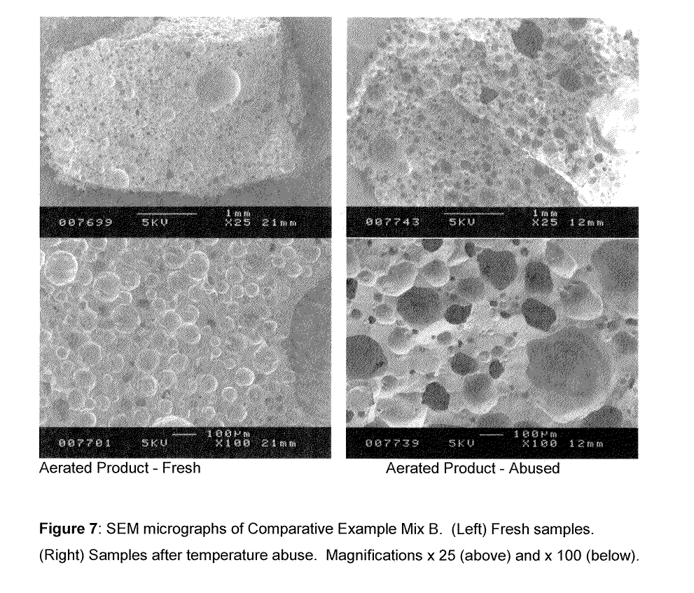

FIGS. 7 to 9 show Scanning Electron Microscope Images of Fresh and Temperature abused Comparative Product B, Product B comprising MCC, and Product D.

### Comparative Product B

The air phase stability of Comparative Product B can be observed in FIG. 7, which shows SEM micrographs of the aerated product before (fresh) and after temperature abuse. The micrographs show the presence of an air phase which destabilises considerably. The fresh sample contains many air bubbles of about 50 to 100 μm diameter. After temperature abuse, however, a large proportion of the air phase is contained in air bubbles which are much greater than 100 μm diameter; i.e. the air phase in this product is not stable to temperature abuse.

This product can be compared directly with Product B in Example 10, which has a similar formulation except that the air phase is stabilised by surface active fibres (MCC with EC). Using the combination of ethyl cellulose and microcrystalline cellulose surface active fibres, the foam is much more stable (FIG. 6) than when surface active particles are not used; i.e. in this comparative example.

Comparative Product B, Comprising MCC (with No EC)

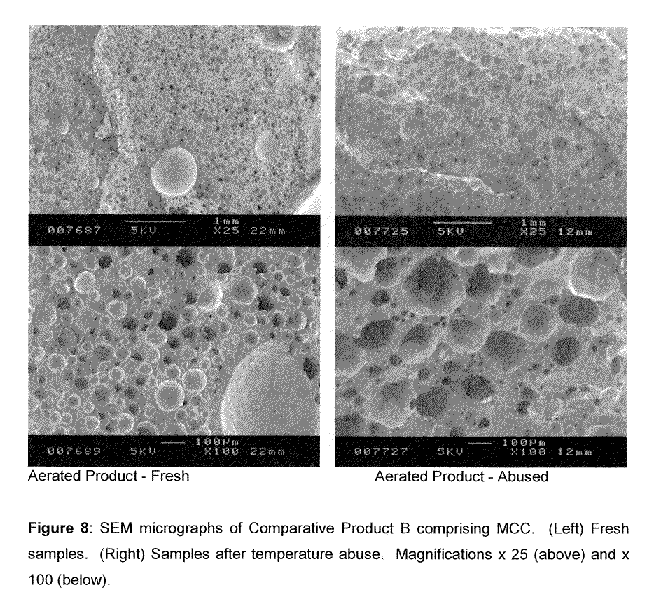

The stability of the air phase in this aerated product is shown in FIG. 8 The micrographs highlight an air phase which is relatively unstable through temperature abuse. This is observed through the significant increase in air bubble size over the abuse regime. The fresh sample has many air bubbles between about 50 and 100 μm, where as the temperature abused sample has a much larger proportion of the air phase in bubbles greater than 100 μm diameter.

These data show that use of microcrystalline cellulose MCC fibres alone do not necessarily provide significant foam stability. In this case, we believe the foam to be stabilised by the milk protein, as is the case of products made using Comparative Example Mixes B and D. The MCC alone is not significantly surface active, and therefore does not contribute to any great extent to foam stability in these frozen systems. In order to stabilise the foam using MCC, then its surface active properties need to be modified, e.g. through the addition of ethyl cellulose which facilitates the adsorption of MCC fibres to the air bubble surface.

### Comparative Product D

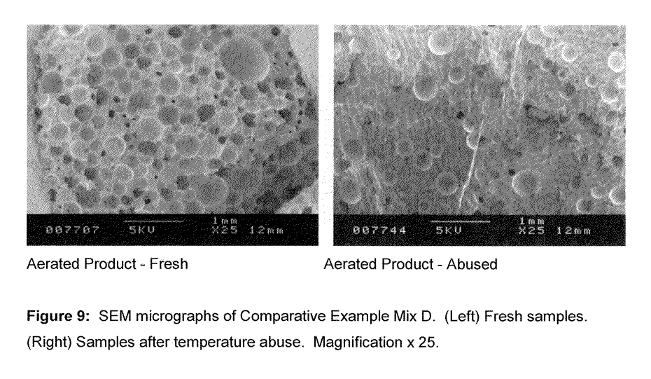

The stability of Comparative Product D is shown in FIG. 9. The micrographs show the presence of an air phase which consists initially (in the fresh sample) of many large air bubbles (>100 μm diameter). These further destabilise and grow through temperature abuse. Furthermore, significant air loss is noted through temperature abuse, i.e. after storage through abuse conditions, there are fewer air bubbles present. Therefore, the air phase in this product can be considered as being very unstable.

This product can be compared directly with Product D in Example 10, which has a similar formulation except that the air phase is stabilised by surface active fibres (MCC with EC). Using the surface active fibres, the foam is much more stable (FIG. 5) than when surface active particles are not used; i.e. in this comparative example.

### Summary

In each of the comparative examples, an air phase is formed which is unstable to temperature abuse, i.e. the bubbles coarsen over time. In each of these cases, surface active fibres (e.g. MCC with EC) are not used to stabilise the foam. The principal foam stabiliser in each case is milk protein, which is typically used to stabilise frozen food foams such as ice cream or sorbet.

However, using the combination of ethyl cellulose and microcrystalline cellulose surface active fibres, the foam is much more stable (as demonstrated in Example 10) than when surface active particles and fibres are not used, or when only surface active particles or only fibres are used.

### Example 12

### Aerated Sorbet, Statically Frozen

This example describes the production of two statically frozen aerated sorbets. One is produced using surface active fibres (MCC with EC) and the comparative example is stabilised using a typical food aerating agent for sorbets, i.e. Hygel.

### Preparation of Base Mix

A sorbet formulation, Mix E, was prepared with the formulation as detailed in Table 5. A 500 g batch was prepared.

TABLE 5
Ingredients and quantities/wt % used to make the Mix E.

| Ingredient | Mix E/wt % |
|---|---|
| Sucrose | 10.5 |
| Cornsyrup, LF9 | 17.3 |
| Guar gum | 0.2 |
| Locust bean gum | 0.3 |
| Hygel | 0.2 |
| Strawberry Puree | 20 |
| Citric acid | 0.2 |
| Water | 51.3 |

Mix E was prepared by mixing the corn syrup in stirring water, then adding all of the dry ingredients. The solution was then heated to and pasteurised 80° C. for 2 minutes. The mix was then cooled by placing in a glycol bath set to −18° C., and the solution stirred until it reached a temperature below 10° C. Subsequently, the strawberry puree was added with mixing and the mix was then stored at 5° C. until use.

Preparation of Aerated Product E, Comprising of MCC and EC

Proportions of the MCC-EC foam phase prepared in Example 7 were blended with Mix E in order to produce foams with approximately 80% Overrun. A proportion of the foam produced was then poured into plastic containers containing approximately 15-20 mL product. These were then placed on solid carbon dioxide (Cardice) in order to freeze. After 30 minutes, these were then transferred to a −80° C. freezer.

### Preparation of Comparative Aerated Product E, in the Absence of MCC and EC

100 mL Mix E was aerated using a Breville mixer, with the Hygel protein acting as the foam stabilising agent. The mix was aerated to 111% overrun. A proportion of the foam produced was then poured into plastic containers containing approximately 15-20 mL product. These were then placed on solid carbon dioxide (Cardice) in order to freeze. After 30 minutes, these were then transferred to a −80° C. freezer.

Storage of all aerated products in this example was performed as described in Example 10. Samples were prepared both “fresh” and “temperature abused”, for subsequent analysis of air phase stability using Scanning Electron Microscopy.

### Results:

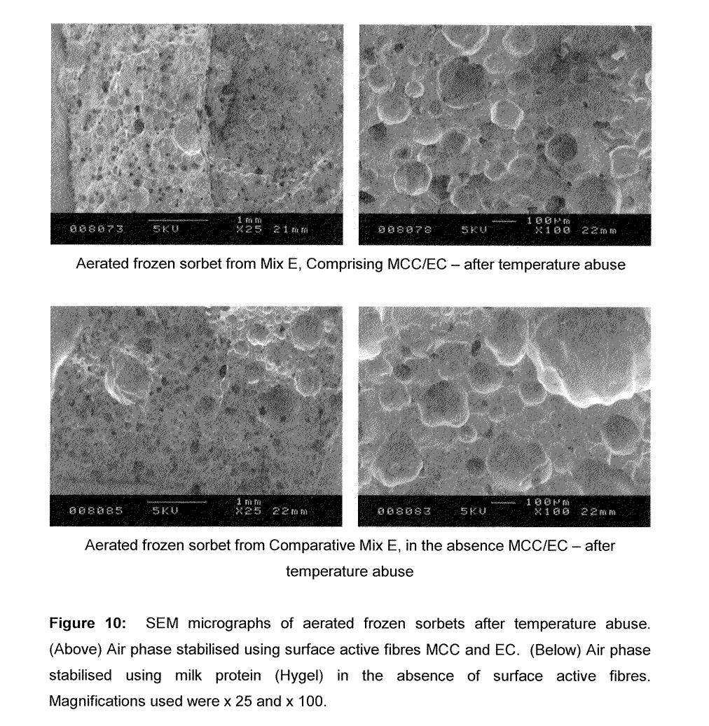

SEM images of the both aerated frozen sorbets after temperature abuse are shown in FIG. 10. It is apparent from these images that the sorbet stabilised using surface active fibres (MCC/EC) produce a foam after temperature abuse which has smaller air bubbles than the comparative sample (stabilised by protein only). It is particularly noticeable that, in the comparative example, there are a greater number of larger air bubbles with diameter greater than about 150-200 μm, compared with the product stabilised by surface active fibres.

Therefore, we can conclude that use of surface active fibres in sorbet formulations can lead to an air phase which is at least as stable (or more stable) as using current formulation technology (i.e. milk protein)

### Example 13

### Aerated Product, Statically Frozen

This example describes the production of a statically frozen aerated product, which comprises high levels of both milk protein (SMP) and liquid oil (SFO). The air phase is stabilised through use of surface active fibres (MCC with EC).

### Preparation of Base Mix

Mix F (high protein/high oil Ice cream) was prepared with the formulation as detailed in Table 6. A 500 g batch was prepared.

TABLE 6
Ingredients and quantities/wt % used to make Mix F.

| Ingredient | Mix F/wt % |
|---|---|
| Sucrose | 25 |
| Xanthan | 0.3 |
| SMP | 10 |
| SFO | 10 |
| Water | 54.7 |

Mix F was prepared by mixing sucrose, skim milk powder and xanthan in stirring water. The solution was then heated to 60° C. and sunflower oil was then added with stirring for 5 minutes. The solution was then mixed using an IKA Ultraturrax (Model T18 Basic, 24,000 rpm 10 minutes) in order to emulsify the oil phase. Immediately afterwards, the solution was subject to Ultrasonication and then the solution was cooled by placing in a glycol bath set to −18° C., and the solution stirred until it reached a temperature below 10° C. The solution was then stored at 5° C. until use.

### Preparation of Aerated Product F, Comprising of MCC and EC

Proportions of the foam phase prepared in Example 7 were blended with Mix F in order to produce foams with approximately 136% Overrun. A proportion of the foam produced was then poured into plastic containers containing approximately 15-20 mL product. These were then placed on solid carbon dioxide (Cardice) in order to freeze. After 30 minutes, these were then transferred to a −80° C. freezer.

Storage of aerated products was performed as described in Example 10. Samples were prepared both “fresh” and “temperature abused”, for subsequent analysis of air phase stability using Scanning Electron Microscopy.

### Results:

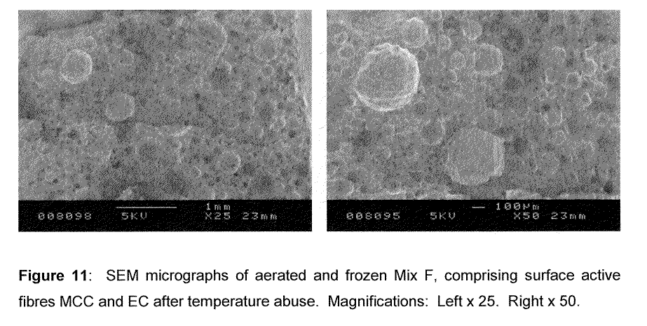

An SEM image of the aerated frozen product after temperature abuse is shown in FIG. 11. From this micrograph it is clear that surface active fibres can be used to stabilise the air phase in a frozen aerated product, even when the formulation comprises significant levels of both milk protein (i.e. another surface active species) and liquid oil. After temperature abuse, many air bubbles of <200 μm diameter remain.

1. A frozen aerated food product having an overrun of at least 30%, comprising 0.001 to 10 wt-%, based on the total weight of the frozen aerated food product, of surface-active fibres, which have an aspect ratio of 10 to 1,000.

2. Frozen aerated food according to claim 1 comprises 0.01 to 8 wt-%, preferably 0.01 to 5 wt-%, based on the total weight of the frozen aerated food product, of surface active fibres.

3. Frozen aerated food product according to claim 1, wherein the fibres have a contact angle at an air/water or at an oil/water interface between 60° and 120°, preferably between 70° and 110°, more preferably between 80° and 100°.

4. Frozen aerated food product according to claim 1, wherein the fibres are made of a food grade waxy material.

5. Frozen aerated food product according to claim 4, wherein the fibres are made of a food grade waxy material, which is natural or artificial.

6. Frozen aerated food product according to claim 4, wherein the fibres are made of a food grade waxy material, which is natural.

7. Frozen aerated food product according to claim 1, wherein the waxy material is carnauba wax, shellac wax or bee wax.

8. Frozen aerated food product according to claim 1, wherein the fibres are made of a non-waxy material, which are modified.

9. Frozen aerated food according to claim 8, wherein the modification is carried by surface active particles.

10. Frozen aerated food product according to claim 9, wherein the surface active particles are ethylcellulose and/or hydroxypropyl-cellulose.

11. Frozen aerated food product according to claim 1, wherein the fibres are organic or inorganic origin.

12. Frozen aerated food product according to claim 1, wherein the fibres are natural or artificial.

13. Frozen aerated food product according to claim 1, wherein the fibres are natural.

14. Frozen aerated food product according to claim 1, wherein the natural fibres are made of a crystalline, insoluble form of carbohydrates, such as microcrystalline cellulose.

15. Frozen aerated food product according to claim 14, wherein the microcrystalline cellulose is obtainable from Acetobacter.

16. Frozen aerated food product according to claim 1, wherein the natural fibres are citrus fibres, onion fibres, tomato fibres, cotton fibres or silk.

17. Frozen aerated food product according to claim 1, wherein the fibres are made from stearic acid, their derivatives and copolymers.

18. Frozen aerated food product according to claim 11, wherein the inorganic fibres are made from calcium based fibres (such as CaCO₃, CaSO₄), ZnO, TiO₂, MgO, MgSO₄, Mg(OH)₂, Mg₂B₂O₅, aluminium borate, potassium titanate, barium titanate, hydroxyapatite and attapulgite.

19. Frozen aerated food product according to claim 11, wherein the inorganic fibres are made from CaCO₃.

20. Frozen aerated food product according to claim 1, wherein the modification of the fibres is achieved by chemical and/or physical means.

21. Frozen aerated food product according to claim 1, wherein the frozen aerated food product is a frozen confection such as ice cream, milk ice, frozen yoghurt, sherbet, slushes, frozen custard, water ice, sorbet, granitas and frozen purees.

22. Frozen aerated food product according to claim 1, which has an overrun of more than 50%, most preferably more than 75%.

23. Frozen aerated food product according to claim 1, which is an ice cream comprising
0.5-18 wt-%, based on the total weight of the ice cream, of fat,
0.5-15 wt-%, based on the total weight of the ice cream, of milk solids not fat
10-30 wt-%, based on the total weight of the ice cream, of sugars
40-75 wt-%, based on the total weight of the ice cream, of water and
0.001-10 wt-%, based on the total weight of the ice cream, of the fibres as defined in claim 1.

24. Frozen aerated food product according to claim 23 comprising liquid oil or a mixture of liquid oils.

25. A premix of a frozen aerated food product as defined in claim 1.

26. A process for the preparation of an frozen aerated food product according to claim 1, wherein
(i) the surface active fibres are aerated in water, in which the aqueous phase can optionally comprise dispersed sugars
(ii) the aerated solution is then mixed with the remaining ingredients that constitute of the food product, and
(iii) the aerated food product is then quiescently frozen.

27. A process for production of a frozen aerated product according to claim 1, comprising the steps of:
(a) preparing an aqueous dispersion comprising surface-active particles,
(b) adding fibres to said dispersion in the form of a dry powder or an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam, and
(d) freezing the obtained foam.
